(19) United States
(12) Patent Application Publication
(10) Pub. No.: US 2007/0183132 A1
(43) Pub. Date: Aug. 9, 2007

(54) Method for the production of the photoelectron the wavelength of which is homogeneous with and resonating at the wavelength of the photoelectron emitted in a cell, promoting the activity of cell

(76) Inventor: Yun Young Ung, Seoul (KR)

Correspondence Address: IP STRATEGIES, 12 1/2 WALL STREET, SUITE I, ASHEVILLE, NC, 28801, US

(21) Appl. No.: 11/410,494

(22) Filed: Apr. 24, 2006

(30) Foreign Application Priority Data
Feb. 6, 2006 (KR) 10-2006-11095

(51) Int. Cl. F21V 9/16; G02B 27/14

(52) U.S. Cl. 362/84; 359/634

(57) ABSTRACT

The present invention relates to a method for the production of the photoelectron the wavelength of which is homogeneous with and resonating at the wavelength of the photoelectron emitted in a cell. Particularly the present invention relates to a method for the production of light energy which utilizes the wavelength of light produced by a means for the luminescence of light, a means for the reflection of light, a means for the dispersion of light, a means for optionally transmitting the wavelength of light, a means for amplifying the wavelength of light through the dispersion, diffraction and interference of light, and a means for optionally absorbing the wavelength of light; adopts material structurally homogeneous with the essential fatty acid which forms cell membranes to activate the energy, repair damaged DNA, and enhance the immune system of a living body; and transmits the light so produced through the material as such to form the wavelength of light which is homogeneous with and resonating at the photoelectrons of the cell.

### FIELD OF INVENTION

The present invention relates to a method for the production of light energy providing from the outside of body cell the light wavelengths (550˜710 nm) resonating on the body cell, which enables the light wavelengths (550˜710 nm) produced by a means for the luminescence of light, a means for the dispersion of light, a means for optionally transmitting the wavelength of light, a means for amplifying the wavelength of light through the dispersion, diffraction and interference of light, and a means for optionally absorbing the wavelength of light to be homogeneous with the wavelengths of both somatic cell's DNA and the essential fatty acid which forms cell membrane, thereby amplifying the photoelectron of cell to activate the energy, repair damaged DNA, and enhance the immune system of body. Particularly the present invention relates to a method for the production of light energy comprising, inside of an airtight cylinder, a visible light source, a plurality of dispersing mills, a plurality of absorbing plates and a reflective plate so that the light emanated from the light source may be reflected by the reflective plate and the brightness of light may be diffused by the dispersion of light, the wavelengths of light may become amplified by the interference of light while the homogeneous lights are passing through a plurality of dispersing mills, and the dispersed homogeneous light may continuously pass through the dispersing mills, and further comprising a film and filters respectively through which the amplified wavelength may pass, the harmful wavelength (400 nm and shorter) may be absorbed and only the wavelength beneficial to human body may pass through, sensors enabling to sense the brightness of the light source and the degree of productiveness of light wavelength when the beneficial wavelength homogeneous with the molecular structure of essential fatty acid passes through the dispersing mills and filters, promoting the activity of body cell, and a camera for taking a picture in moving images of the thermal change condition of light wavelength subject for an appraisal.

### SUMMARY OF INVENTION

The present invention is intended to provide a method for the production of light which produces the light wavelengths (550˜710 nm) by a means for the luminescence of light, a means for the reflection of light, a means for the dispersion of light, a means for optionally transmitting the wavelength of light, a means for amplifying the wavelength of light through the dispersion, diffraction and interference of light, and a means for optionally absorbing the wavelength of light; adopts a material homogeneous with the essential fatty add of body cell; radiates such wavelengths to the body to amplify the resonance on the body cell; and resultantly activates the energy of body, repairs damaged DNA, and enhance the immune system, thereby promoting the activity of cell.

The present invention is based on biophotogenesis, the J Williams' theory that the energy of light wavelength motion generated in ATP (adenosine triphophate) is coded by cell's DNA and released, the F. Popp's theory put forth in ‘Biophoton Emission’ that the so called biophoton, that is, minute quantities of light energy emitted from DNA promote all the functions of physiological metabolism such as communication between cells, protein biosynthesis, muscular contraction motion, delivery by cell membrane of material, and so forth, the theory established by Szent Gyorgi who found that light promotes 500% the effect of self-repairing ability of damaged DNA and the enzyme function involving in repairing DNA, the J. Lieberman's theory that on light energy depends the driving force of two major organic structures, the autonomic nervous system and the endocrine system, which are responsible for health, balance, adjustment, control, and so forth, and the F. Popp and B. Ruth's theory that the external resonant stimulation into the biophoton of living organism raises the activation of energy in the body up to 10⁴⁰.

Also, the present invention is based on F. Popp's thesis titled Biophoton Emission, which argues that the light wavelength motion energy produced by the hydrolysis of ATP, the source of cellular energy, being coded in chromosomal DNA, minute quantities of photon energy, that is, biophoton is emitted.

The present invention is based on the hypothesis that the quantities of light energy emitted in the body cell can measure the activation of a living body, and the wavelength of light homogeneous with the light energy mentioned in the above is absorbed into the cell while resonating on the light energy of living body, enabling to amplify the light energy of cell.

The present invention is also intended to provide a method which can produce minute quantities of light energy resonating on the light energy of a living body, and measure the light energy.

The present invention uses a general light source of three wave 20 watt fluorescent, but any light source generating a visible light is also allowable.

The environment effected by the brightness of light is comprised to be able to be expanded by means of bigger electricity and relevant devices.

The present invention is comprised for the light emitted from the light source to keep the uniformity of brightness; the strength of light is amplified by means of a reflective plate; and prisms are used for the dispersion of light.

The present invention is based on both the Budwig's contention that the major chemical molecule absorbing the light energy in a living body be essential fatty acid (c=c-c-o) and the Adey's theory that, in order for a living body to absorb an electromagnetic wave and decode the information, its frequency be a particular one that can be resonant and absorbable, while its strength should be tenuous not to destroy the structure of protein which plays a role for the detection of information.

In the present invention, a transparent body of acryl (c=c-o) homogeneous with the molecular structure (c=c-c-o) of linoleic and linolenic acid of essential fatty add is used for the prism mentioned in the above, but the present invention does not limit the material for the prism to acryl.

The present invention is intended to intercept harmful light and comprise the photoelectron capable of resonating on a body cell.

The present invention is also intended to laminate the prism disks to induce the interference, diffraction, and amplification of light that transmits the prism, amplifying the light wavelength strong.

The present invention comprises a reflective internal cylinder to gather the lights at the center and amplify the lights, then move the lights toward the one direction.

The present invention further comprises an instrument to measure quantitatively and in moving images the brightness of lamp installed in the apparatus for the production of the photoelectron; the wavelength of the light produced according to the present invention; and the thermal changes of the light wave subject.

### BRIEF DESCRIPTION OF DRAWINGS

FIG. 1 is a general view of the apparatus for the production of the photoelectron according to the present invention.

Fig. A of 2 is an A-A′ line sectional view of the apparatus for the production of the photoelectron according to the present invention.

Fig. B of 2 is a B-B line cross-sectional view of the apparatus for the production of the photoelectron according to the present invention.

FIG. 3 is a separating view of the apparatus for the production of the photoelectron according to the present invention.

### MAJOR CODES OF DRAWINGS

| | |
|---|---|
| 11: Case | 12: Internal Cylinder |
| 13: Lamp | 14: Reflective Plate |
| 15: Cylinder Prism | 16: Prism Disk |
| 17: Yellow Filter (a, b) | 18: Blue Filter |
| 19: Black Filter | 20: Fixing Plate |
| 21: Fan | 22: Inlet |
| 23: Outlet | 24: Stand |
| 25: Signal Panel | 26: Rubber Ring |
| 27: Camera | 29: Sensors (a, b) |
| 31: Fixing Ring | 32: Handle |
| 33: Control Panel | |

### DETAILED DESCRIPTION OF THE PREFERRED EMBODIMENT

The present invention comprises a means for the luminescence of light, a means for amplification of the light strength, a means for the dispersion of light, a means for optionally absorbing the wavelengths of light, and a means for sensing the strength of electric light and the strength of the photoelectron.

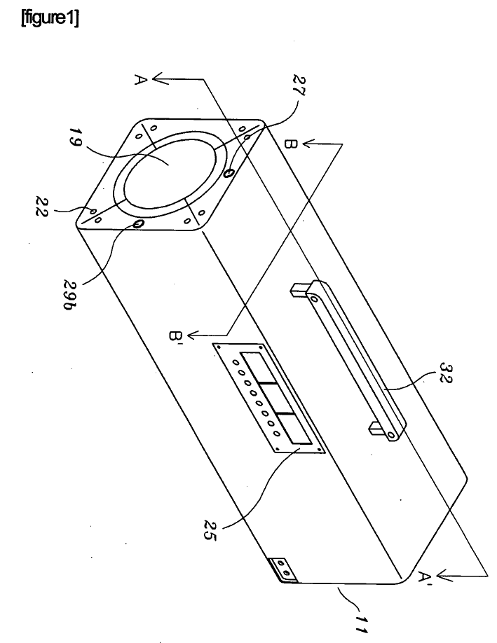

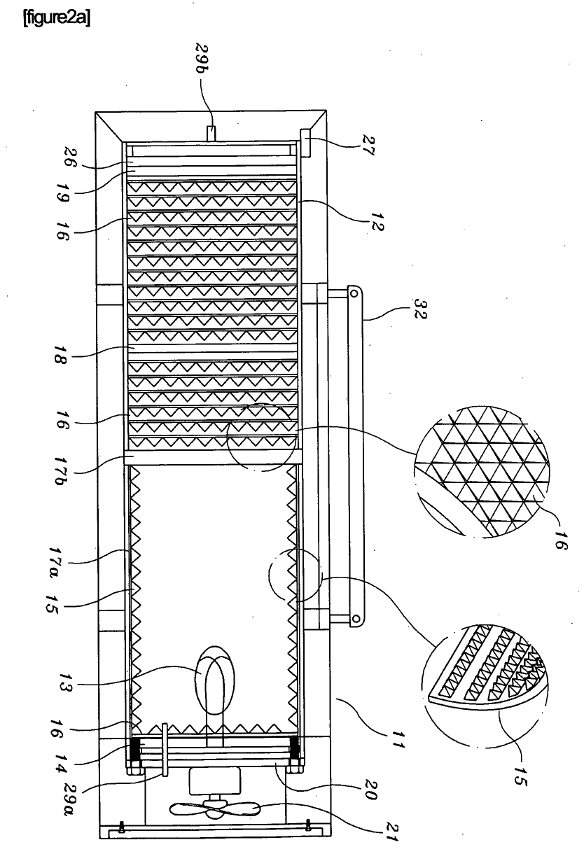

FIG. 1 illustrates a view of the apparatus for the production of the photoelectron according to the present invention,

Fig. A of 2 illustrates an internal structure of the apparatus for the production of the photoelectron according to the present invention,

Fig. B of 2 illustrates a cross-sectional view of the apparatus for the production of the photoelectron according to the present invention, and

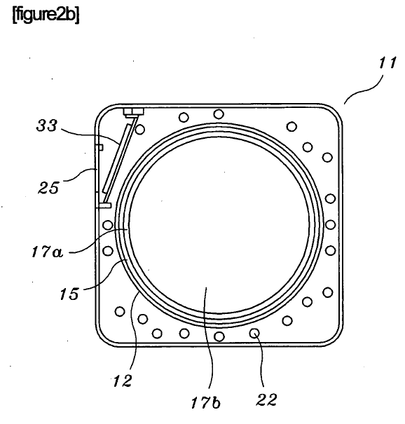

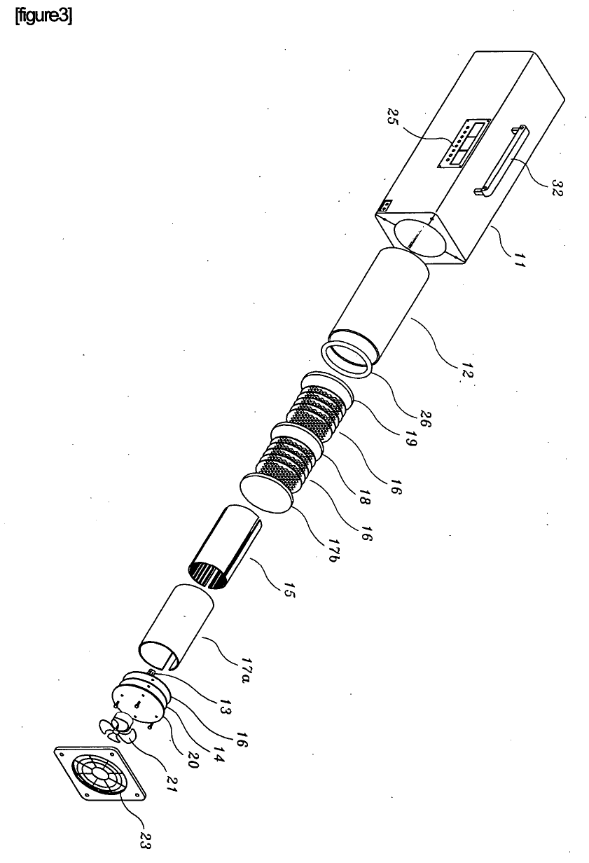

FIG. 3 illustrates a separating view in details of the internal structure of the apparatus for the production of the photoelectron according to the present invention.

The internal cylinder (12) used in the present invention is in cylinder shape, and its inner wall is treated to reflect light. The internal cylinder (12) in cylinder shape is intended to gather the reflected lights at the center, amplifying the strength of the gathered photoelectrons, and the reflective plate (14) is intended to move the amplified photoelectrons toward the front direction of the reflective plate (14). The prism disks (16) combined in the front side of the reflective plate (14), and the prism cylinder (15) inserted into the internal cylinder (12) and adhered closely to the inside diameter of the internal cylinder (12) are intended to disperse lights. The fixing plate (20) located in the rear of the internal cylinder (12) is inserted into the internal cylinder (12) and fixed by the socket connection.

The socket mentioned in the above is comprised to combine with a three wave fluorescent or a lamp (13) enabling to emit a visible light. Toward the inside of the fixing plate (20) mentioned in the above is combined a metal reflective plate (14) enable to reflect light with the fixing plate (20), and toward the front of the reflective plate (14) are laminated a plurality of prism disks (16) of acryl material with the prisms formed to stick out as shown in FIG. 3. A rubber ring (26) is inserted and fixed to the front inner circumference of the internal cylinder (12).

A black filter (19) of acryl material is inserted into the internal cylinder (12) and pushed closely against the rubber ring (26), and toward the inside of the black filter (19) are laminated a plurality of prism disks (16) with the prisms formed to stick out, and toward the inside of the laminated prism disks (16) is placed a blue filter (18) of acryl material, as shown in FIG. 3.

The black filter (19) is comprised to absorb the visible light wavelength of red color and shorter, and the blue filter (18) to absorb the visible light wavelength of blue color and shorter.

Toward the inside of the blue filter (18) are laminated a plurality of prism disks (16) with a plurality of the prisms formed to stick out, identical with the prisms mentioned in the above, as illustrated in Fig. A of 2 and FIG. 3.

The placement of the prism disks (16) laminated with the prisms formed to stick out is based on the Thomas Young's wave motion theory of light that, when a light passes through the prism disks (16) and two homogeneous wavelengths overlap each other, the ridges of wavelength mix each other strongly and the chasms of wavelength mix each other weakly, bringing about a phenomenon that two wavelengths interfere, and, when n number of wavelengths overlap each other, the interference of wavelength increases in proportion to n number of wavelengths and the strength of wavelength increases in proportion to the number of wavelengths.

Toward the inside of the laminated prism disks (16) is placed a yellow filter (17b) as illustrated in Fig. A of 2 and FIG. 3

The yellow filter (17a) is comprised to absorb the visible light wavelength (400 nm) of yellow color and shorter.

The placement of the yellow, blue and black filter (17a, 18, and 19) in the order from the light source is intended to gradually absorb the shorter wavelengths.

Toward the inside of the yellow filter (17b) in the above is the cylinder prism (15) comprised with one end of the cylinder prism (15) surrounded closely by the inside diameter of the internal cylinder and formed to support the yellow filter (17b) and the other end of the cylinder prism (15) formed to be jointed closely to the prism disks (16) assembled with the reflective plate (14).

The cylinder prism (15) is formed in two or more pieces so that the cylinder prism (15) can be inserted into the internal cylinder (12) with ease.

In the rear of the fixing plate (20) of the internal cylinder (12) is formed a fan (21), which can force the heat radiated from the internal cylinder (12) to exhaust.

On the fixing plate (20) mentioned in the above is fixed a detachable light sensor (29a) with one end formed to be exposed in front of the prism disks (16) of the reflective plate (14). The fixing plate (20) above is comprised to be able to be fixed to the internal cylinder (20). Around the outside of internal cylinder (12) above is secured a required space for the inflow of air from the outside and the exhaust of the heat radiated from the outside diameter of the internal cylinder (12), and the inside diameter of the case (11) and the outer diameter of the internal cylinder (12) are combined as shown in Fig. A and B of 2, with the front part of the internal cylinder (12) fixed at the entrance of the case (11) as shown in Fig. A of 2 and with the rear part of the internal cylinder (12) fixed and supported by a fixing ring (31). On the upper part of the case (11) is formed a concealable handle (32).

On the front part of the case (11) is formed a light sensor (29b) sensing the strength and quantity of the photoelectron generated from the internal cylinder (12) and moving as illustrated in Fig. A of 2.

On the side of the case (11) is formed a signal panel (25) indicating the motion of the sensors (29a, 29b) as illustrated in FIGS. 1 and 3.

Inside of the signal panel (25) is formed a control panel (33) to be able to control the motion of the sensors (29a, 29b) and a camera (27).

The stand (24) for the case (11) formed underneath the case (11) rotates so that one or the other end of the case (11) can be lowered or raised and the case (11) can be moved right and left.

The order being followed as shown in FIG. 3, the rubber ring (26) is inserted from the rear end of the internal cylinder (12), and pushed all the way to the front end of the internal cylinder (12).

Likewise, the black filter (19) is inserted, and pushed against the rubber ring (26).

After the black filter (19) is inserted, a plurality (10˜15) of prism disks (16) laminated closely are inserted with the prisms facing forward. Then, the blue filter (18) is inserted and laminated with the prism disks (16). After the blue filter (18) is inserted, another plurality (10˜15) of prism disks laminated closely (16) are inserted with the prisms facing forward as described in the above.

After the prism disks (16) are placed to be laminated, the yellow filter (17) is inserted. Next to the yellow filter (17) is placed the cylinder prism (15) one end of which contacts the rear end of internal cylinder (12) and the other end of which contacts, and is fixed by, the fixing plate (20).

The cylinder prism (15) can be comprised of two or three pieces to make the insertion easy, in which case the pieces are inserted separately and combined together to form a complete cylinder prism in the internal cylinder (12).

It is possible to insert the yellow film (17a) around the inside diameter of the internal cylinder (12) prior to the cylinder prism (15) so that the yellow film is placed between the internal cylinder (12) and the cylinder prism (15).

After the cylinder prism (15) is inserted, the lamp socket is fixed; the reflective plate (14) and the prism disk (16) are inserted to round the socket, leaving no space in between; the fixing plate (20) formed in the rear of prism disk (16) with a fan (21) mounted on is inserted into the internal cylinder (12); the fixing plate (20) above is pieced with, and fixed to, the internal cylinder (12) when the cylinder prism (15) is inserted into the internal cylinder (12) until the round edge of prism disk (16) contacts, and presses against, that of the cylinder prism (15). The sensor (29a) is inserted from the rear of the fixing plate (20) and fixed with one end exposed in front of the prism disk (16).

In the front part of the case is formed the sensor (29b) which is inserted from the inside of inner wall of case (11) with one end exposed to the outside of inner wall of the case (11), and, thereafter, the internal cylinder (12) is inserted from the rear end of the case (11). Once the internal cylinder (12) is inserted into the inside of the case (11), the part of front inner wall of the case (11), which is from the top of internal cylinder (12) to the rubber ring (26), is a lead-in of the internal cylinder (12).

The case (11) is comprised to be able to support the load of the internal cylinder (12). Once the internal cylinder (12) is inserted into the case (11), the fixing rings (31) are formed to fix the internal cylinder (12) to the case (11) so that the internal cylinder (12) is not allowed to move backward as shown in Fig. A of 2.

After the case (11) and the internal cylinder (12) are combined, the stand (24) is placed and comprised to be able to move the case (11) up and down or right and left.

Each switches on the signal panel (25) being turned on, the lamp (13), the fan (21), two sensors (29a, 29b), and the camera (27) begin to start up accordingly. When the light is turned on the lamp (13), the reflective plate (14) in the rear, which is comprised to reflect the light around the lamp (13) (back, circumference), forces the light to move forward, then the light is dispersed and reflected by the prism disks (16), and the reflective inner wall of the internal cylinder (12) reflects and gathers the lights at the center, and, while gathering at the center, the dispersed lights are amplified in wavelengths.

The prisms of the prism disks (16) mentioned in the above being of an equilaterally triangular pyramid shape, the lights are dispersed, no matter what direction the lights are incident from. The wavelength of yellow color in a visible light is 400 nm.

Also, while the light, after passing through the cylinder prism (15), is passing through the yellow film (17a), the light the wavelength of which is shorter than 400 nm is absorbed, and the light the wavelength of which is 400 nm and longer is reflected.

The dispersed light, whose wavelength is 400 nm and longer is amplified in wavelengths, thereafter moves forward, as mentioned in the above.

The light energy, after moving forward, passes through the yellow filter (17b), while the wavelength shorter than 400 nm (ref Experiment 2) is being absorbed again, and the wavelength of 400 nm and longer pass through a plurality of the prism disks (16).

While the light is passing through the yellow filter (17b) and a plurality of the prism disks (16), it looses the brightness, only the selected wavelengths of light pass through, and the light becomes amplified in wavelength by the interference of wavelength.

While the amplified wavelengths of light are passing through the blue filter (18), the wavelengths shorter than 550 nm are again being absorbed, and the wavelengths of 550 nm and longer only pass through.

The wavelength of blue color in a visible light is 500˜550 nm.

While, after passing through the blue filter (18), the wavelengths of light pass through the prism disks (16), the wavelengths of light are amplified by the interference and diffraction of light, and while the amplified wavelengths are passing through the black filter (19), the wavelengths shorter than 700 nm and the quantities of light are to be absorbed (Ref. Experiment 2). When the wavelengths of light, after passing through the prism disks (16) and each filters (17b, 18, 19), pass through the black filter (19), only the wavelengths of 700 nm and longer are to pass through. And the wavelengths shorter than 700 nm possibly pass through, but the present invention is comprised to absorb harmful wavelengths completely.

Essential fatty acid, which forms the cell membrane of human body, is known to increase 1,000 times the capacity to react upon oxygen when it absorbs light.

The essential fatty add is capable of storing light energy in molecule and using it when necessary, has the core function to supply each cells with oxygen, and activates when absorbing the light of optional wavelengths.

Correspond to the wavelengths capable of passing through essential fatty acid, the wavelengths (700˜720 nm) of light energy according to the present invention are comprised to be able to secure the big resonance in essential fatty acid.

Actual Example

Now the present invention will be described based on an actual example.

The present invention is intended to produce the photoelectron capable of resonating on the essential fatty acid of healthy cell but in the material homogeneous with the essential fatty acid of cell, and strike the cell from the outside of cell, promoting the activation of cell. The material used in the present invention is a transparent plate comprised of acryl plastic. The prism acryl plate according to the present invention is comprised to be made of the material, the molecular structure of which is -c=c-c-o and homogeneous with the molecule of linoleic and linolenic acid of the cell membrane forming essential fatty acid so that the photoelectron filtered by acryl plastic may pass through the essential fatty acid and resonate on the photoelectron of cell in the essential fatty add with ease. The prism disks (16) according to the present invention are formed on the transparent acryl plate with triangular pyramids sticking out, as illustrated in FIG. 5(?).

The triangular pyramid above is comprised of the structure identical with a prism.

It is comprised that the light, passing from the base face toward the pyramid, are dispersed in the two faces of pyramid.

In the actual example according to the present invention, the internal cylinder (12) is comprised principally, but not necessarily, in cylinder shape, and, in any case, the interior is comprised for the light to be reflected with ease.

Experiment-1

Korea Research Institute of Standards and Science

Title of Experiment

A Spectral Irradiation Test by the Apparatus According to the Present Invention

Table-1 indicates the strength of light per wavelength.

The horizontal (X) axis indicates the wavelength of light in numerical value, and the vertical (Y) axis indicates the strength of light in numerical value.

[image]

[image]

Table-1 above shows the result of a spectral irradiation test conducted in Korea Research Institute of Standards and Science with the apparatus according to the present invention, where the strength of light the wavelength of which ranges from 400 nm to 750 nm is shown, and it is noticeable that the light the wavelength of which ranges from about 550 nm to 710 nm is irradiated, as shown in Table-1.

Especially the 700 nm wavelength range is noticeably irradiated.

Experiment-2

Korea Institute of Science and Technology

Title of Studies

1. A Test for the Nature of the Apparatus for the Production of the Photoelectron According to the Present Invention and the Effect of the Nature of the Apparatus for the Production of the Photoelectron on Water

1) Test for the Nature of Apparatus
   (1) The Nature of the Apparatus
      An incandescent light (20 w, 220˜230v, 50˜60 Hz) emitting the wavelengths of visible light, ultraviolet light, and infrared light was adopted for the light source of the apparatus.
   (2) The absorbance and transmittance of the yellow film and the blue filter used for the color balancer of the apparatus were measured by a UV-visible spectrometer.
   (3) The light absorbance and transmittance of the prism disks were measured by a UV-visible spectrometer.
   (4) The light absorbance and transmittance of the opaque acrylic filter installed at the entrance of the apparatus were measured by a UV-visible spectrometer.

[image]

Table-2 above indicates the transmittance of light which passes through the yellow film and yellow filter according to the present invention.

In Table-2, the horizontal (X) axis indicates the wavelength of light in numerical value, and the vertical (Y) axis indicates the transmittance of light in numerical value.

It is noticeable that the light begins to transmit as the wavelength is getting bigger than 300 nm, and the transmittance quantities drop in between 400 nm and 500 nm but increase in 500 nm, and further that only small quantities of light emitted from the apparatus according to the present invention transmit in wavelengths from 400 nm to 500 nm, but the light hardly transmits in the wavelength shorter than 300 nm, as illustrated in Table-2.

[image]

Table-3 above indicates the transmittance of light which passes through the blue filter according to the present invention.

The horizontal (X) axis of Table-3 is the wavelength of light in numerical value, and the vertical (Y) axis is the transmittance of light in numerical value.

It is noticeable that the light begins to transmit as the wavelength is getting bigger than 300 nm and the transmittance quantities drop in the wavelength between 600 nm and 700 nm but increase in the wavelength of 710 nm and longer, as illustrated in Table-3.

In other words, the transmittance quantities of light emitting from the apparatus according to the present invention increase in the wavelength between 300 nm and 650 nm and also in the wavelength of 700 nm and longer, and the light hardly transmits in the wavelength shorter than 300 nm.

[image]

Table-4 above indicates the transmittance of light which passes through the prism disks according to the present invention.

The horizontal (X) axis of Table-3 is the wavelength of light in numerical value, and the vertical (Y) axis is the transmittance of light in numerical value.

It is noticeable that the transmittance increases in the wavelength of 300 nm and longer.

[image]

Table-5 above indicates the transmittance of light which passes through the black filter according to the present invention.

The horizontal (X) axis is the wavelength of light in numerical value, and the vertical (Y) axis is the transmittance of light in numerical value.

It is noticeable that the transmittance of light which passed through the black filter is almost same from ultraviolet light to infrared light, as illustrated in Table-5 above.

The black filter according to the present invention is comprised to adjust the quantity of light transmittance.

[image]

Table-6 above indicates the absorbance of light wavelength which transmits the yellow film and the yellow filter according to the present invention.

The horizontal (X) axis of Table 6 above is the wavelength of light in numerical value, and the vertical (Y) axis is the absorbance of light in numerical value.

It is noticeable that a great quantity of light is absorbed in the wavelength shorter than 300 nm, a significant quantity of light in the wavelengths of 400 nm to 500 nm, and a negligible quantity in the wavelengths of 500 nm and longer.

[image]

Table-7 above indicates the absorbance of light wavelength which transmits the blue filter according to the present invention.

The horizontal (X) axis of Table 7 above is the wavelength of light in numerical value, and the vertical (Y) axis is the absorbance of light in numerical value.

It is noticeable that a great quantity of light is absorbed in the wavelength shorter than 400 nm, a significant quantity in the wavelength of 500 nm to 700 nm, and a negligible quantity in the wavelength of 700 nm and longer, as shown in Table-7.

[image]

Table-8 above indicates the absorbance of light wavelength which transmits the prism disks according to the present invention.

The horizontal (X) axis of Table 8 above is the wavelength of light in numerical value, and the vertical (Y) axis is the absorbance of light in numerical value.

It is noticeable that a great quantity of light is absorbed in the wavelength shorter than 300 nm and a medium quantity of light in the wavelength of 300 nm and longer.

[image]

Table-9 above indicates the absorbance of light wavelength which transmits the black filter according to the present invention.

The horizontal (X) axis of Table 9 above is the wavelength of light in numerical value, and the vertical (Y) axis is the absorbance of light in numerical value.

It is noticeable that the wavelengths are mostly absorbed, as illustrated in Table-9.
2) The Effect of the Apparatus on Water

A one liter container filled with 800 ml of the water distilled just now being installed 3 cm apart from the entrance of apparatus and irradiated for five days, the pH of distilled water was measured.

The distilled water irradiated by the light of the apparatus changed as shown in Table-10.

TABLE 10

| irradiation time(hrs) | pH |
|---|---|
| 0 | 6.84 |
| 8 | 6.97 |
| 16 | 7.35 |
| 22 | 7.50 |
| 30 | 7.86 |
| 39 | 8.30 |
| 48 | 8.40 |
| 59 | 8.42 |
| 99 | 8.44 |

Table-10 shows the measurement of change in the distilled water irradiated by the light of apparatus.

It is noticeable that the pH climbs with big points for first 40 hours of irradiation, but turns into small-point climbs as the times exceeded 40 hours, as shown in Table-10.

TABLE 11
Omitted

| minutes lapsed(minutes) | DH |
|---|---|
| 0 | 8.30 |
| 1 | 8.06 |
| 1.5 | 7.95 |
| 2 | 7.88 |
| 2.5 | 7.80 |
| 3 | 7.74 |
| 3.5 | 7.65 |
| 4 | 7.58 |
| 4.5 | 7.49 |
| 5 | 7.40 |
| 5.5 | 7.37 |
| 6 | 7.33 |
| 6.5 | 7.22 |
| 7 | 7.13 |

The water was irradiated for 40 hours through the apparatus according to the present invention, as shown in Table-10, then the apparatus was removed and the pH of water was examined. As a result, the pH of water decreased as hours elapsed, as shown in Table-11.

As shown in the above, the light irradiated from the apparatus according to the present invention can bring about a change in the pH of water.

It can be noted from the result of the experiment above that a molecule of water ionizes when releasing a high energy. A molecule of water ionizes, forming an electron, the so called hydrated electro, and the hydrated electro reacts with water to form a hydrogen atom and a hydroxyl ion, which change water into electropositive.

Because a conclusion can be drawn from the experiment above that the light produced by the apparatus according to the present invention releases the wavelengths ranging from 700 nm to 720 nm more than any other range, it follows that the hydrated electro of water exists in the wavelengths ranging from 700 nm to 720 nm more than in any other range. According to the Bohr's theory that water occupies 55.0% of human body and the reaction of hemoglobin in blood with oxygen means the increases in the strength of oxygen by the increase in pH, it can be rightly argued that the light produced by the apparatus according to the present invention is able to increase oxygen in the human body.

Experiment-3

Research Institute for Veterinary Science

1. The Title of Study

The Productivity of the Physical World and the Biologically Effective Change by the Irradiation of the Apparatus According to the Present Invention

2. Objective

1) The Productivity Change of Physical World
2) An Examination on the Functional Analysis of Immunocyte in the Body of Chicken
   3. The Method of Experiment

A group irradiated by the apparatus and a group not irradiated by the apparatus were experimented, a blood chemical test was conducted for a biologically effective test, and MHC class II and leukocyte antigen such as CD4, CD8, B and so forth were examined for a peripheral blood mononuclear cell population distribution analysis.

A test for infectious bronchitis and HI titer and an ELISA test for infectious bursal disease were conducted to check the pathogenic contamination of the test group, and a clinical and pathological test and a skin and real organ tissue test were conducted to check the apparatus.

The peripheral blood mononuclear cell population distribution analysis showed that the distribution of positive rate for antigen-presenting cells, B lymphocytes and some of the activated T lymphocytes, and the MHC class II revealed on the surface was 90% higher in the test group than in the non-test group.

The positive rate of peculiar monoclonal antibody, differently from the common antigen of granulocyte and monocyte, was 8 times higher in the test group than in the non-test group.

It was confirmed that the irradiation of the apparatus according to the present invention increases the granulocyte and the monocyte playing an important role in the first immune defensive mechanism against the pathogen of chicken in the test group, and activated the MHC class II carrying out a central function in immune response.

The power switch of the apparatus being turned on, the 20 w three wave fluorescent (13) emits light. The lights generated from the fluorescent (13) radiate 360-degree, and the radiated lights are comprised to travel straight forward.

Example:

The reflective plate (14) is formed in the rear of the fluorescent (13), the lamp (13) is surrounded by the inside diameter of the internal cylinder (12), the inside diameter of internal cylinder (12) is comprised to reflect light, the reflected lights are comprised to gather at the center of internal cylinder (12), and the reflective plate (14) in the rear is comprised to reflect the lights to travel straight forward.

In front of the reflective plate (14) mentioned in the above are combined a plurality of the prism disks (16), the cylinder prism (15) is inserted into the internal cylinder (12), the yellow film (17a) is placed between internal cylinder (12) and the cylinder prism (15), the light, when passing through the cylinder prism (15), is dispersed and the wavelengths shorter than 400 nm, when passing through the yellow film (17a), are absorbed, the wavelengths of the dispersed light shorter than 400 nm are again absorbed and the dispersed lights gather at the center of the internal cylinder (12), and the reflective plate (14) in the rear reflects the lights to travel straight forward. Thus, the wavelengths shorter than 400 nm of the light reflected in the internal cylinder (12) above are absorbed, and the wavelengths shorter than 400 nm of the light reflected in the rear and the light radiated forward are not absorbed, therefore all the lights traveling forward are to pass through the yellow filter (17b).

The wavelength shorter than 400 nm, when passing through the yellow filter (17b), is absorbed.

The wavelength of 40 nm and longer pass through the yellow filter (17b), and, while passing through a plurality of prism disks (16), repeat the dispersion, diffraction and interference of light, and resultantly the quantities of light decrease, the wavelengths are amplified, and the amplified wavelengths move forward.

When homogeneous lights overlap, the wavelengths of light, by nature, are to interfere and diffract with the wavelengths amplified.

The lights pass through a plurality of the prism disks (16), and, when the passing through the blue filter (18), the wavelength shorter than 400 nm is absorbed.

The reason why the short wavelengths are treated not to pass through is because the short wavelengths are harmful to human body.

While the wavelengths of lights which passed through the blue filter (18) are passing through a plurality of the prism disks (16), the quantities of light decrease and the wavelengths are amplified.

The wavelengths of lights which were able pass through the composition described in the above range 700 nm to 720 nm (Ref. Experiment-2).

The wavelengths are mostly absorbed when passing through the black filter (19), and very small quantities of wavelength pass through.

It is for the comprisal of the strength and wavelength of light enabling to resonate on a cell that the wavelengths are optionally absorbed and repeatedly amplified, and the light wavelength sizes are adjusted, as described in the above. Also, the strength and wavelength of light desirable as such (Ref. Experiments-1, 2, 3) is necessary to prevent from being destroyed the protein which delivers the information of a cell.

For the uniformity, convenience, and safety of performance of the apparatus according to the present invention, the inlets (22) are formed on the case (11) as shown in FIG. 1 in order to eliminate the heat generated from the outer surface of internal cylinder (12), and the outlet (23) is formed, as shown in FIG. 3, in order to issue heat out through the operation of the fan formed on the fixing plate. The sensor (29a) is installed inside of internal cylinder (12) to measure the light energy from the lamp (13) as shown in Fig. A of 2, and the lamp (13) is exchangeable in time.

The sensor (29a) installed in the front side of internal cylinder (12) measures the light energy released from internal cylinder (12), and the signal panel (25) formed on the outside of the case (11) indicates the measurement, as shown in FIG. 1.

A camera (27) installed in the front side of the case (11) as shown in FIG. 1 takes a picture of the thermal condition of the subject from time to time, showing the moving images on the signal panel (25).

Underneath the case (11) is installed a stand (24), which is comprised to move the apparatus right and left or high and low to adjust the direction according to the position of the subject.

The present invention enables to amplify the resonance on a body cell, combine the hyperbaric oxygen of blood with the hemoglobin, and produce the wavelengths of light homogeneous with the wavelengths of essential fatty acid, activating the energy of human body, repairing damaged DNA, and enhancing the immune system, and comprises a means for the luminescence of light, a means for the amplification of light, a means for the dispersion of light, a means for the selection of light, a means for the expansion of light through the diffraction and interference of light wavelengths, and a means for the absorbance of light in order to amplify the wavelength of light, absorb the harmful light wavelengths, only for the beneficial wavelengths to pass through, and especially for the minute quantities of wavelengths ranging from 550 nm to 720 nm to pass through by making the use of the black filter.

1. A method for the production of the photoelectron the wavelength of which is homogeneous with and resonating at the wavelength of the photoelectron emitted in a cell, promoting the activity of cell comprising:
A division of an internal cylinder and a case; and, inside of the internal cylinder, a means for the luminescence of light, a means for the reflection of light, a means for the dispersion of light, a means for the transmittance of light wavelength, a means for the expansion of wavelength through the dispersion, diffraction and interference of light, a means for the absorbance of light, a means for sensing the brightness of a means for the luminescence of light, and a means for sensing the quantity of emanating light wavelength.

2. A method for the production of the photoelectron the wavelength of which is homogeneous with and resonating at the wavelength of the photoelectron emitted in a cell, promoting the activity of cell as claimed in claim 1, wherein the means for the luminescence of light is characteristic of being comprised of a lamp where a visible light is produced.

3. A method for the production of the photoelectron the wavelength of which is homogeneous with and resonating at the wavelength of the photoelectron emitted in a cell, promoting the activity of cell as claimed in claim 1, which is characteristic of an internal cylinder made of the metal material and formed in cylinder shape with the inner wall being treated to reflect light; a rubber ring formed in the inside diameter of the front end of internal cylinder, combined with and fixed to internal cylinder; a light absorbing black filter combined in the rear side of the rubber ring; a plurality of prism disks for the dispersion, diffraction, and amplification of light combined to overlap each other in the rear of the rubber ring; a light absorbing blue filter combined in the rear of the prism disks; a plurality of prism disks for the dispersion, diffraction, and amplification of light combined to overlap each other; a light absorbing yellow filter combined in the rear of the prism disks; a cylinder prism for the dispersion of light inserted into the internal cylinder; a light absorbing yellow film placed between the inside diameter of internal cylinder and the outside diameter of cylinder prism; and, in the rear end of the internal cylinder, a lamp, a plate for reflecting light forward, a prism disk for dispersing the reflected light, and a fixing plate formed and combined to be fixed to a prism disk.

4. A method for the production of the photoelectron the wavelength of which is homogeneous with and resonating at the wavelength of the photoelectron emitted in a cell, promoting the activity of cell as claimed in claim 1, wherein the means for the luminescence of light is characteristic of a visible light producing lamp.

5. A method for the production of the photoelectron the wavelength of which is homogeneous with and resonating at the wavelength of the photoelectron emitted in a cell, promoting the activity of cell as claimed in claim 1, which is characteristic of a case with a cylinder space formed inside into which an internal cylinder is inserted; on the both ends of the case are formed a plurality of outlet to exhaust the heat radiated from the outer circumference of the internal cylinder and a plurality of inlet to take in the air from the outside; and a fan is formed on the back side of fixing plate to force the heat to exhaust.

6. A method for the production of the photoelectron the wavelength of which is homogeneous with and resonating at the wavelength of the photoelectron emitted in a cell, promoting the activity of cell as claimed in claim 3, which is characteristic of a sensor for the detection of the degree of brightness of lamp which is inserted from the back side of fixing plate, pieces through a reflective plate, and sticks out of a prism disks.

7. A method for the production of the photoelectron the wavelength of which is homogeneous with and resonating at the wavelength of the photoelectron emitted in a cell, promoting the activity of cell as claimed in claim 1, which is characteristic of a sensor which is installed to the inside of the case toward the entrance of the internal cylinder, and enables to measure the light energy emitted from the internal cylinder.

8. A method for the production of the photoelectron the wavelength of which is homogeneous with and resonating at the wavelength of the photoelectron emitted in a cell, promoting the activity of cell as claimed in claim 1, which is characteristic of a camera installed in the front side of the case and comprised to take the picture of the thermal condition of the subject in moving images.

9. A method for the production of the photoelectron the wavelength of which is homogeneous with and resonating at the wavelength of the photoelectron emitted in a cell, promoting the activity of cell as claimed in claim 1, which is characteristic of a sensor installed inside of internal cylinder to measure the brightness of lamp; a sensor installed outside of the case to measure the light energy; a signal panel formed on the outside of the case to show the thermal condition of subject picture taken by the camera in moving images; and a control panel formed Inside of the signal panel to control the sensors and the moving images taken by the camera.

10. A method for the production of the photoelectron the wavelength of which is homogeneous with and resonating at the wavelength of the photoelectron emitted in a cell, promoting the activity of cell as claimed in claim 1, which is characteristic of a stand bendable right or left and high or low which is installed underneath the case to adjust the direction toward the subject.
